(19) United States
(12) Patent Application Publication
(10) Pub. No.: US 2006/0265359 A1
(43) Pub. Date: Nov. 23, 2006

(54) Flexible data-bound user interfaces

(75) Inventors: Alexandru D. Burst, Bellevue, WA (US); Alisson A.S. Sol, Redmond, WA (US); David Koronthaly, Issaquah, WA (US); Ricard Roma Dalfo, Redmond, WA (US); Scott M. Isaacs, Sammamish, WA (US); Maarten W. Mullender, Bellevue, WA (US); Parichay Saxena, Bellevue, WA (US); Todd Abel, Redmond, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/133,162

(22) Filed: May 18, 2005

(51) Int. Cl. G06F 17/30

(52) U.S. Cl. 707/3

(57) ABSTRACT

A facility for creating and using flexible data-bound user interfaces is described. In some embodiments, the facility receives an indication of a reference that is contained within a document loaded by a client application. The reference indicates a line of business application containing information corresponding to the reference. The facility requests the line of business application for line of business information corresponding to the reference. When it receives the requested information, the facility directs the client application to render a user interface component based on the received information. The received information may contain rendering information and line of business information.

### TECHNICAL FIELD

The described technology relates generally to graphical user interfaces and more particularly to flexible data-bound user interfaces.

### BACKGROUND

Information workers are people who create, use, or manipulate information. These workers often employ multiple software applications to complete their tasks. As an example, information workers use office productivity software, such as MICROSOFT OFFICE applications to input, modify, or format information. This information may be provided by or to other applications, such as “line of business” (“LOB”) applications. LOB applications sometimes have client-side components that operate on a client computing device and server-side components that operate on a server computing device. The server-side components typically employ an associated database that stores data that is manipulated to provide information required by information workers. As an example, server-side components of LOB applications may employ relational databases, data warehouses, etc.

Office productivity software and LOB applications are generally not integrated. When software applications are not integrated, users perform a “context switch” when they use the software applications. A context switch occurs when a user stops performing a task to perform another task. As an example, a user producing a sales proposal using MICROSOFT WORD may stop working on the sales proposal to switch to an LOB application's client-side component to produce information, copy the information to an electronic clipboard, and paste the information from the electronic clipboard into MICROSOFT WORD. Causing a user to leave a task to perform another task disrupts the user's ability to be efficient and productive. This problem is exacerbated when the user needs to retrieve information from multiple LOB applications. As an example, the user producing the sales proposal may need to collect sales information from a sales LOB application, marketing information from another LOB application, etc. It would thus be highly desirable to provide a facility for creating and using flexible data-bound user interfaces.

### BRIEF DESCRIPTION OF THE DRAWINGS

FIG. 1 is a block diagram illustrating an example of a suitable computing environment in which aspects of the facility may be implemented.

FIG. 2 is a block diagram illustrating an environment in which the facility operates in some embodiments.

FIG. 3 is a block diagram illustrating a client of FIG. 2 in further detail.

FIG. 4 is a block diagram illustrating a server of FIG. 2 in further detail.

FIG. 5 is a block diagram illustrating the data engine of FIG. 3 in further detail.

FIG. 6 is a message flow diagram illustrating a flow of requests and responses among various components of the facility in some embodiments.

FIG. 7 is a flow diagram illustrating a request_data routine in some embodiments.

FIG. 8 is a flow diagram illustrating a provide_data routine in some embodiments.

FIG. 9 is a flow diagram illustrating a render_UI routine in some embodiments.

FIG. 10 is a block diagram illustrating a user interface of the facility in some embodiments.

FIG. 11 is a block diagram illustrating the task pane of FIG. 10 in further detail.

FIG. 12 is a block diagram illustrating a page of FIG. 11 in further detail.

FIG. 13 is a flow diagram illustrating a routine performed by an aspect of the facility in some embodiments.

### DETAILED DESCRIPTION

A facility is provided for creating and using flexible data-bound user interfaces. In some embodiments, the facility retrieves information from one of several LOB applications based on an identifier (e.g., a “reference”) in a document loaded by an application and directs the application to render data relating to the retrieved information based on rendering information received with the data.

In some embodiments, when an application loads a document or refreshes a portion of a document containing a reference (also referred to herein as a “tag”), a bridge component of the facility provides the reference to a data engine component of the facility. The reference is similar to a uniform resource locator (“URL”), and has a scheme part and a scheme-specific part. As an example, the reference may be “XYZ://database/table/row,” which specifies an “XYZ” scheme part and a “database/table/row” scheme-specific part. Based on the reference, the data engine component selects one of several LOB components associated with the data engine component that corresponds to the reference. As an example, the data engine component determines, based on the reference “XYZ://database/table/row,” that an XYZ LOB component corresponds to the XYZ scheme. The selected LOB component identifies from the scheme-specific part what information is to be retrieved, retrieves the identified information, and provides the retrieved information to a user interface (“UI”) engine. The selected LOB component may employ a corresponding LOB application's web service to retrieve the information. The retrieved information may include rendering information and data. The UI engine directs the application to display the data portion of the retrieved information according to the rendering information. As an example, the UI engine may direct the application to display the information within the document or in a separate task pane. The UI engine may employ an object model provided by the application to control the application. In some embodiments, the rendering information may be stored as metadata. An example of metadata is provided below. Thus, the UI can be defined in a declarative manner in which positioning and other information can be provided in metadata rather than source or executable code.

In some embodiments, the facility adds a task pane to the application that loads the document. The UI engine may direct the application to add the task pane when it receives information from the data engine indicating that data is to be provided in a task pane. The task pane is a window associated with the application. A user or the UI engine can cause the task pane to be displayed in various forms. As examples, the user or UI engine can minimize or maximize a task pane, or attach the task pane to the application. Alternatively, the user or UI engine can close the task pane or dissociate it from the application so that the task pane does not reduce the amount of screen space available to the application or its document. When the task pane is dissociated from the application, it can be hidden from view by the user or UI engine, such as by positioning it “below” the application's window.

In some embodiments, the task pane has multiple windows and one or more tabs. When a user selects one of the tabs, information relating to a task is brought to the “front” window within the task. Each window of the task may have multiple pages. A user or the UI engine can move, resize, close, or reopen each page. Each page can have multiple regions. The user can also move, resize, close, or reopen each region. The user or UI engine can also reposition a page or region so that the page or region does not appear to be associated with the task pane.

In some embodiments, other software components, such as software components provided by a third party, can also manipulate task panes, pages, and regions. As an example, a systems integrator may desire to add, remove, or modify information relating to tasks provided by a software vendor. Thus, portions of the task pane are said to be data-bound. Similarly, portions of the document loaded by the application are also data-bound when the UI engine places data directly in the document based on a reference.

By employing the facility, the user may not need to determine from which LOB application to retrieve data and can instead focus on the tasks at hand. As an example, when the user loads a document containing a sales proposal containing references to LOB applications, relevant data is made available either in the document or in the task pane without any significant intervention by the user. The facility thus provides flexible data-bound user interfaces.

### Figures Illustrating Various Embodiments

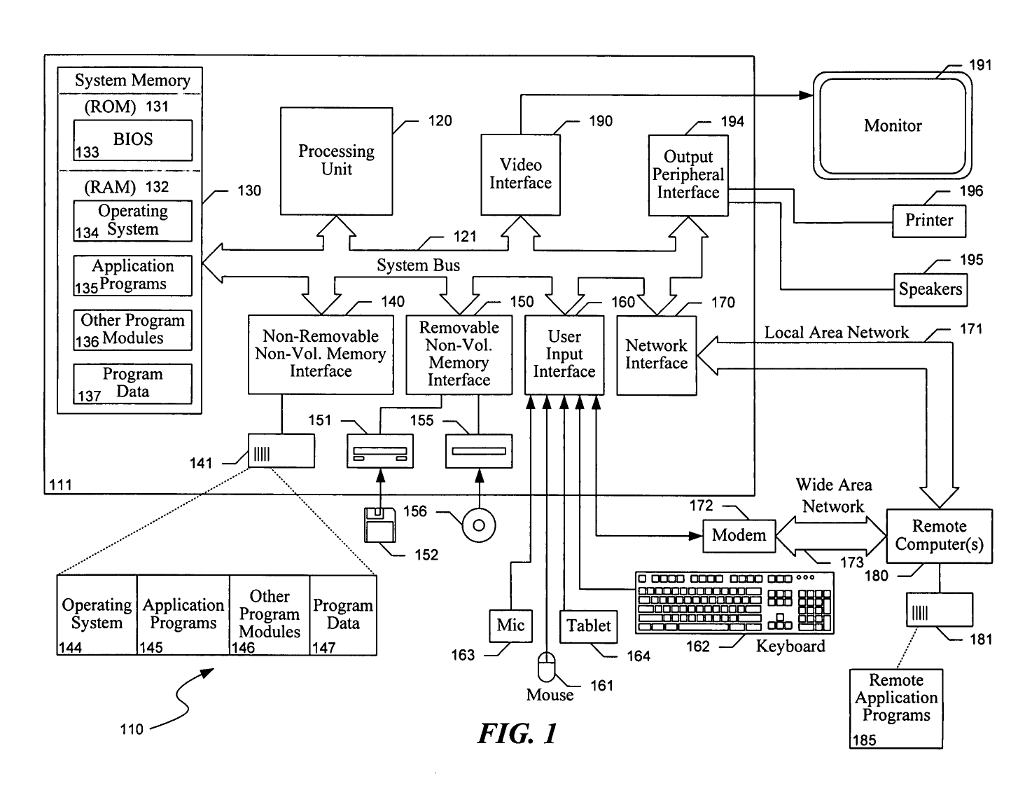

Turning now to the figures, FIG. 1 is a block diagram illustrating an example of a suitable computing system environment 110 or operating environment in which the techniques or facility may be implemented. The computing system environment 110 is only one example of a suitable computing environment and is not intended to suggest any limitation as to the scope of use or functionality of the facility. Neither should the computing system environment 110 be interpreted as having any dependency or requirement relating to any one or a combination of components illustrated in the exemplary operating environment 110.

The facility is operational with numerous other general purpose or special purpose computing system environments or configurations. Examples of well-known computing systems, environments, and/or configurations that may be suitable for use with the facility include, but are not limited to, personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The facility may be described in the general context of computer-executable instructions, such as program modules, being executed by a computer. Generally, program modules include routines, programs, objects, components, data structures, and so forth that perform particular tasks or implement particular abstract data types. The facility may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the facility includes a general purpose computing device in the form of a computer 111. Components of the computer 111 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as a Mezzanine bus.

The computer 111 typically includes a variety of computer-readable media. Computer-readable media can be any available media that can be accessed by the computer 111 and includes both volatile and nonvolatile media and removable and nonremovable media. By way of example, and not limitation, computer-readable media may comprise computer storage media and communication media. Computer storage media include volatile and nonvolatile, removable and nonremovable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 111. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media, such as a wired network or direct-wired connection, and wireless media, such as acoustic, RF, infrared, and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within the computer 111, such as during start-up, is typically stored in ROM 131. RAM 132 typically contains data and/or program modules that are immediately accessible to and/or presently being operated on by the processing unit 120. By way of example, and not limitation, FIG. 1 illustrates an operating system 134, application programs 135, other program modules 136, and program data 137.

The computer 111 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a nonremovable memory interface, such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 111. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 111 through input devices such as a tablet or electronic digitizer 164, a microphone 163, a keyboard 162, and a pointing device 161, commonly referred to as a mouse, trackball, or touch pad. Other input devices not shown in FIG. 1 may include a joystick, game pad, satellite dish, scanner, or the like. These and other input devices are often connected to the processing unit 120 through a user input interface 160 that is coupled to the system bus 121, but may be connected by other interface and bus structures, such as a parallel port, game port, or a universal serial bus (USB). A monitor 191 or other type of display device is also connected to the system bus 121 via an interface, such as a video interface 190. The monitor 191 may also be integrated with a touch-screen panel or the like. Note that the monitor 191 and/or touch screen panel can be physically coupled to a housing in which the computer 111 is incorporated, such as in a tablet-type personal computer. In addition, computing devices such as the computer 111 may also include other peripheral output devices such as speakers 195 and a printer 196, which may be connected through an output peripheral interface 194 or the like.

The computer 111 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 111, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprisewide computer networks, intranets, and the Internet. For example, in the present facility, the computer 111 may comprise the source machine from which data is being migrated, and the remote computer 180 may comprise the destination machine. Note, however, that source and destination machines need not be connected by a network or any other means, but instead, data may be migrated via any media capable of being written by the source platform and read by the destination platform or platforms.

When used in a LAN networking environment, the computer 111 is connected to the LAN 171 through a network interface or adapter 170. When used in a WAN networking environment, the computer 111 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 111, or portions thereof, may be stored in the remote memory storage device 181. By way of example, and not limitation, FIG. 1 illustrates remote application programs 185 as residing on memory storage device 181. It will be appreciated that the network connections shown are exemplary and other means of establishing a communications link between the computers may be used.

While various functionalities and data are shown in FIG. 1 as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

The facility may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in some embodiments.

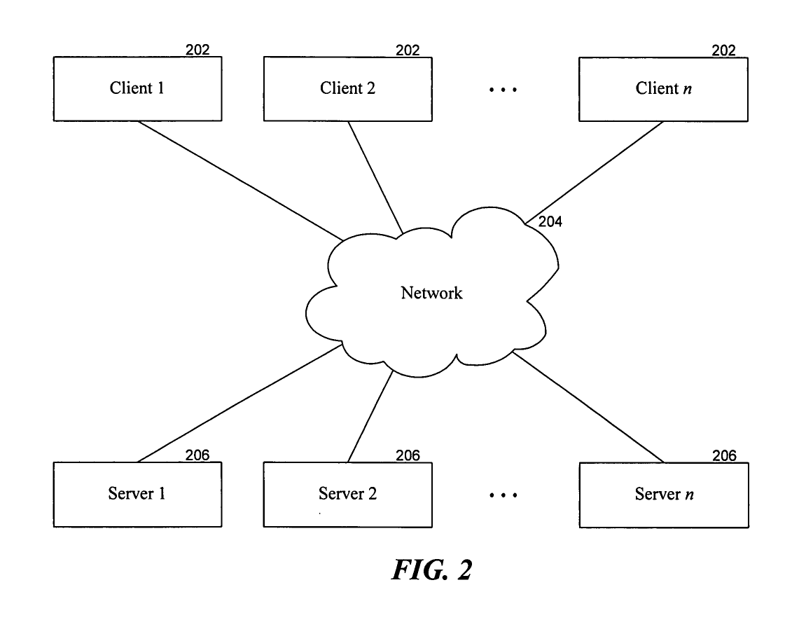

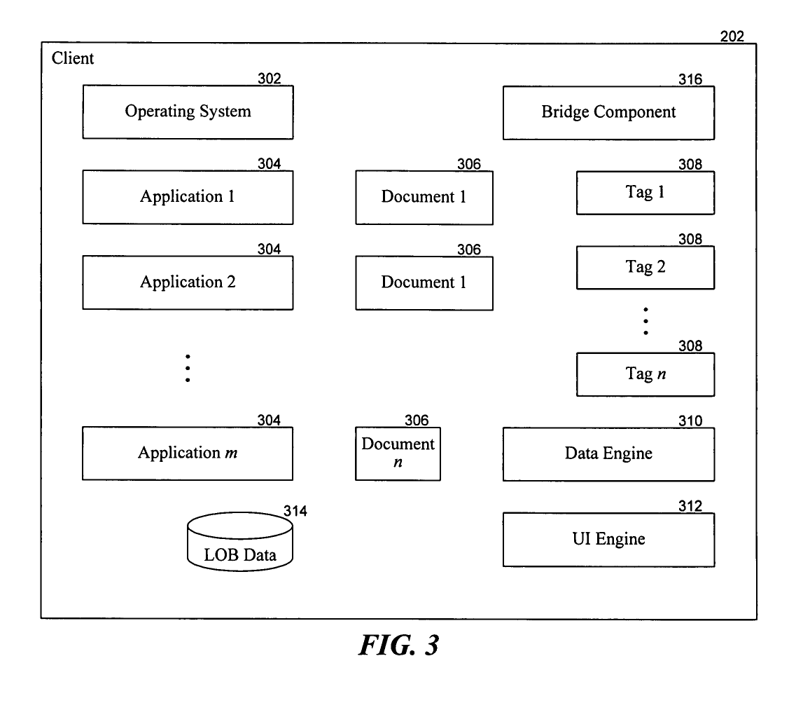

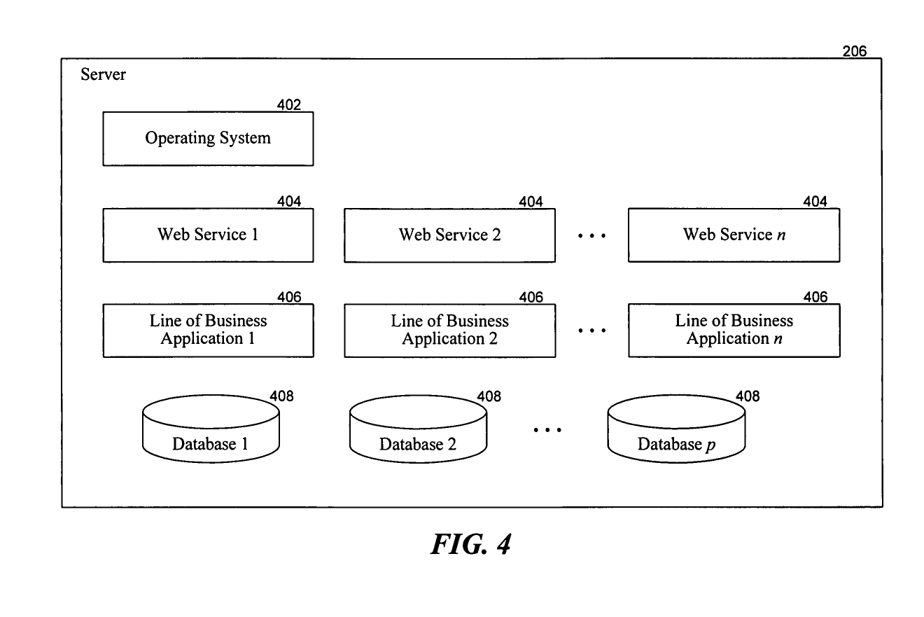

FIG. 2 is a block diagram illustrating an environment in which the facility operates in some embodiments. The environment includes one or more clients 202 that communicate via a network 204 to one or more servers 206. The client and server computing devices are similar to the computing device described above in relation to FIG. 1. The network 204 may be the Internet, an intranet, or any other form of network. The clients and servers are further described below in relation to FIGS. 3-4.

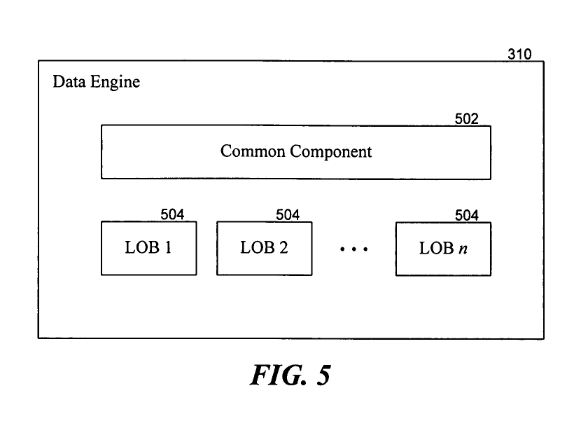

FIG. 3 is a block diagram illustrating a client of FIG. 2 in further detail. In some embodiments, the client 202 has an operating system 302, one or more applications 304, documents 306 associated with the applications, and tags 308 (or “references”) embedded in the documents. The client also has a data engine 310 (as described in further detail below in relation to FIG. 5), a UI engine 312, a database containing data 314 relating to the data engine's LOB components (which are described in greater detail below in relation to FIG. 5), and a bridge component 316.

The applications may be any application that the facility supports. As an example, the applications may be office productivity applications, such as MICROSOFT WORD, MICROSOFT EXCEL, MICROSOFT OUTLOOK, MICROSOFT POWERPOINT, or indeed any MICROSOFT OFFICE application.

An application 304 may load a document 306. As an example, MICROSOFT WORD may load a WORD document 306. The document may contain one or more tags 308. The tag may provide an indication of a data source, such as LOB data from an LOB application. In some embodiments, the indication is similar to a URL. When the document contains a tag, the bridge component 316 may provide the tag to the data engine 310. The bridge component may be associated with the document or the application. As an example, the bridge component may be a dynamic link library (“DLL”) that the application loads.

The data engine determines which of several LOB components corresponds to the tag. The data engine then requests the determined LOB component to retrieve information from a server. When the data engine receives the requested information, it provides the received information to the UI engine 312.

The UI engine separates the received information into rendering information and LOB data. The UI engine then directs the application to display the received LOB data according to the rendering information provided therein. In some embodiments, aspects of the received information may be in an extensible markup language, such as XML.

The data engine determines which LOB component corresponds to the tag by comparing portions of the tag with data stored in the database 314. The database 314 may store this information as metadata. Metadata is generally high-level data that describes other data. The database may contain metadata that describes relationships between tags and LOB components of the data engine. As an example, the metadata may specify a relationship between a scheme portion of tags and LOB components of the data engine.

FIG. 4 is a block diagram illustrating a server of FIG. 2 in further detail. In some embodiments, the server 206 has an operating system 402, one or more web services 404, one or more LOB applications 406, and one or more databases 408.

Each web service 404 may correspond to an LOB application 406. As an example, a SAP application may have an associated web service, and a SIEBEL application may have another associated web service. SAP and SIEBEL are companies that produce enterprise software. The web services provide an interface that other software components can employ to communicate with the LOB application. As an example, the web service may provide a Simple Object Access Protocol (SOAP) interface or an interface defined by a Web Service Definition Language (WSDL).

Each application may have one or more associated databases. Although the databases are illustrated in the figure as part of the server, the databases may be stored in a different server in some embodiments.

FIG. 5 is a block diagram illustrating the data engine of FIG. 3 in further detail. In some embodiments, the data engine 310 has a common component 502 and one or more LOB components 504. The common component provides an interface to other software components, such as the bridge component 316 of the client. In some embodiments, the common component determines which of the several LOB components should be employed to service a request. As an example, when the common component receives a tag and a request for data, the common component determines which of the LOB components corresponds to the tag and requests the corresponding LOB component to retrieve the data from an LOB application residing on a server.

The data engine may be implemented as a DLL. The data engine retrieves metadata information from the database 314, such as information relating to a correspondence between tags and LOB components. The LOB components may be implemented as DLLs or other software components that are provided by vendors of the LOB applications. As an example, SAP may provide an LOB component. Similarly, SIEBEL may provide another LOB component. These LOB components may be installed on the client. Alternatively, the LOB components may be retrieved from a server.

The common and LOB components have program logic that is provided by computer-executable instructions. They may also have additional logic provided by metadata or stored therein.

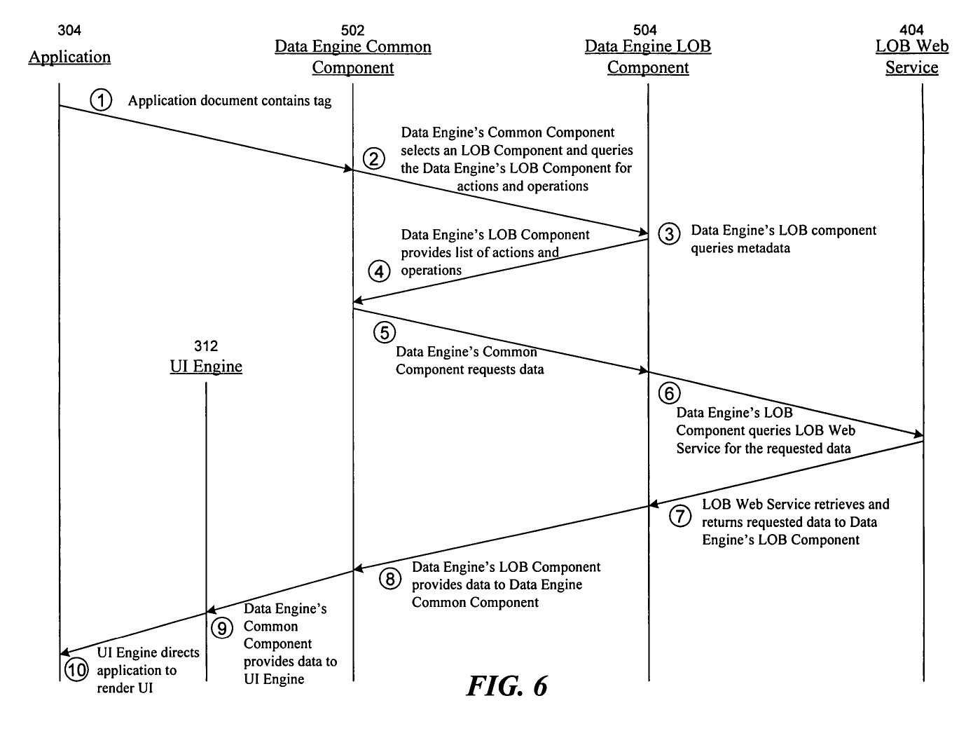

FIG. 6 is a message flow diagram illustrating a flow of requests and responses among various components of the facility in some embodiments. An application 304 may load a document or refresh an area of a document that contains a tag. When this occurs, the bridge component 316 provides an indication of the tag to the data engine's common component 502. The data engine's common component selects one of the data engine's LOB components 504 and queries the selected LOB component for actions and operations relating to the tag. The LOB component then provides a list of actions and operations to the data engine common component. Each LOB component provides a known interface that is employed by the common component. The LOB component then utilizes an interface provided by its corresponding web service component 404. In some embodiments, the interface of the web service may not be publicly known. The actions and operations are indications of services provided by the LOB application corresponding to the LOB component. The common component then requests information from the LOB component. The LOB component queries the LOB web service for the requested information. The LOB web service retrieves the requested information from its database and provides the requested information to the LOB component. The LOB component provides the received information to the common component which then provides this information to the UI engine 312. The UI engine separates the received information into rendering information and LOB data. The UI engine then directs the application to render appropriate UI based on the rendering information.

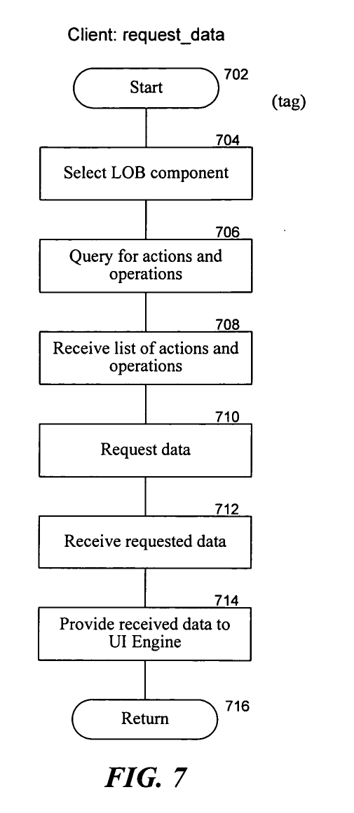

FIG. 7 is a flow diagram illustrating a request_data routine in some embodiments. The data engine's common component may perform the routine. The routine begins at block 702 where it receives a tag as a parameter.

At block 704, the routine selects an LOB component. The routine may select the LOB component based on the received tag. As an example, the routine may determine a correspondence between tags and LOB components based on data stored in the database 314.

At block 706, the routine queries for actions and operations. As an example, the routine may query the selected LOB component for the actions and operations.

At block 708, the routine receives a list of actions and operations corresponding to the query sent at block 706.

At block 710, the routine requests data. As an example, the routine may send a request for data to the LOB component selected at block 704.

At block 712, the routine receives the requested data. The data may be received in various forms, such as XML, text, or indeed any form in which data is exchanged between software components or computing devices.

At block 714, the routine provides the received data to the UI engine 312.

The routine returns at block 716.

In some embodiments, the routine may query for actions and operations, such as at block 706, at a different time than when it requests data, such as at block 710. In these embodiments, the routine may return after block 708 and then may begin later at block 710.

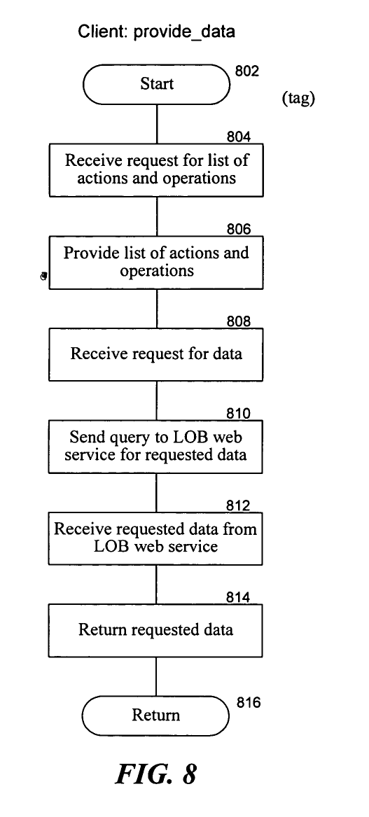

FIG. 8 is a flow diagram illustrating a provide_data routine in some embodiments. The data engine's LOB component may perform the routine. The routine begins at block 802.

At block 804, the routine receives a request for a list of actions and operations.

At block 806, the routine provides an indication of a list of actions and operations. As an example, the routine may retrieve the list of actions and operations from the database 314 based on the received tag.

The routine begins at block 802 where it receives a tag as a parameter.

At block 808, the routine receives a request for data. As an example, the routine may receive the request from the data engine's common component when the bridge component detects that its corresponding application has loaded a document containing a tag or is refreshing an area of the document.

At block 810, the routine sends a query to the LOB web service corresponding to the LOB component selected at block 704 for the requested data.

At block 812, the routine receives the requested data from the LOB web service.

At block 814, the routine returns the requested data to its caller.

At block 816, the routine returns.

In some embodiments, the request of block 804 and the request of block 808 are received at different times. As an example, the routine may return after block 806 and then may receive a request for data at block 808 separately.

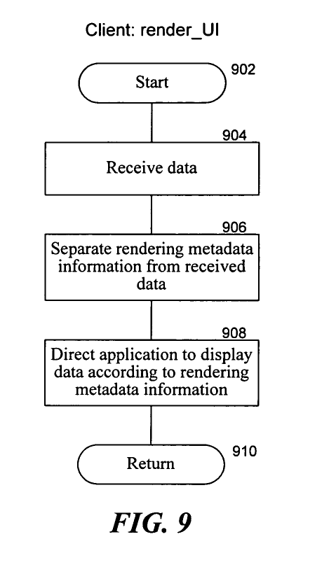

FIG. 9 is a flow diagram illustrating a render_UI routine in some embodiments. The routine begins at block 902.

At block 904, the routine receives data. As an example, the routine may receive data from the data engine's common component 502.

At block 906, the routine separates from the received data rendering metadata information and LOB data. The rendering metadata information provides instructions or directions to the UI engine on how to display the data. As an example, the rendering information may specify that the data is to be displayed in a particular format or in a particular region of the UI.

At block 908, the routine directs the application 304 to display the received LOB data according to the rendering metadata information.

The routine returns at block 910.

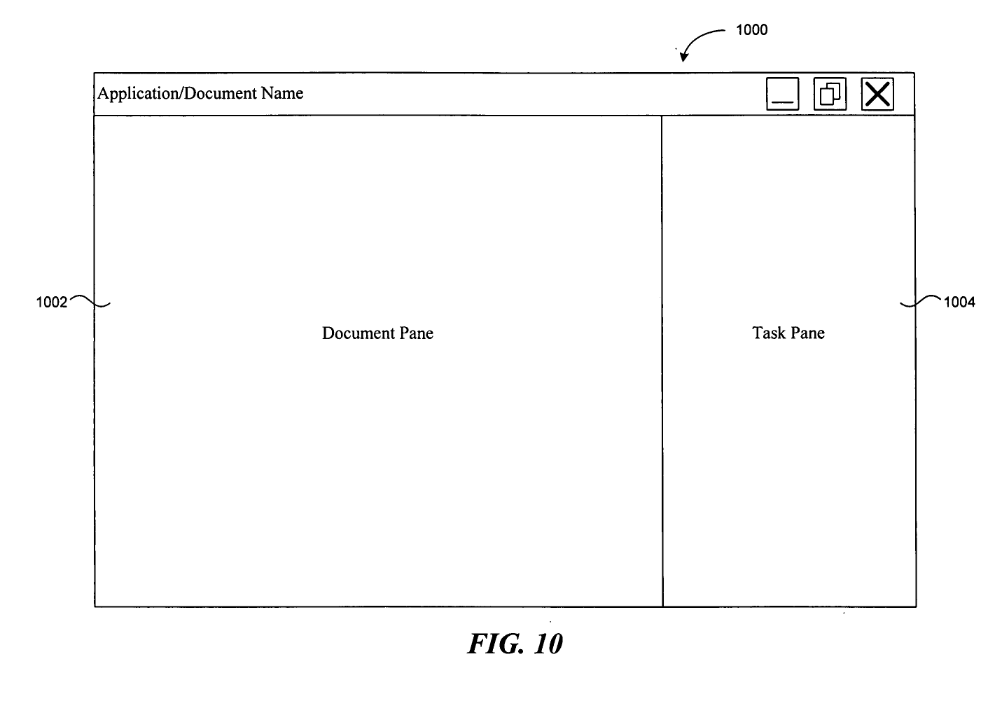

FIG. 10 is a block diagram illustrating a user interface of the facility in some embodiments. The UI 1000 has a document pane 1002 and a task pane 1004. The application 304 loads documents into the document pane 1002. The UI engine directs the application to render UI either in the document pane 1002 or the task pane 1004. As an example, a vendor name may be displayed next to an invoice number in the document. In contrast, other invoices relating to the vendor may be displayed in the task pane.

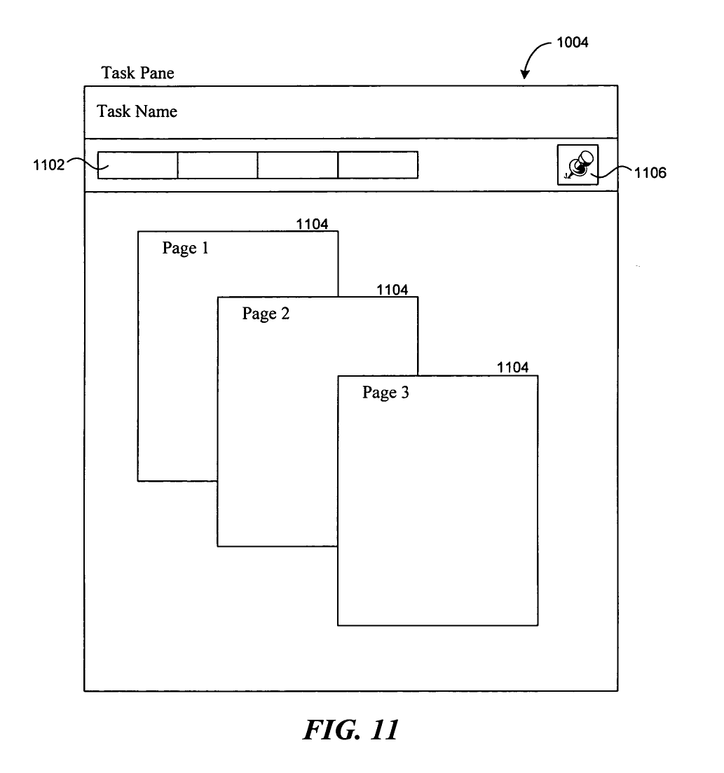

FIG. 11 is a block diagram illustrating the task pane of FIG. 10 in further detail. In some embodiments, the task pane has one or more tabs 1102, one or more pages 1104, and various controls, such as a pushpin 1106.

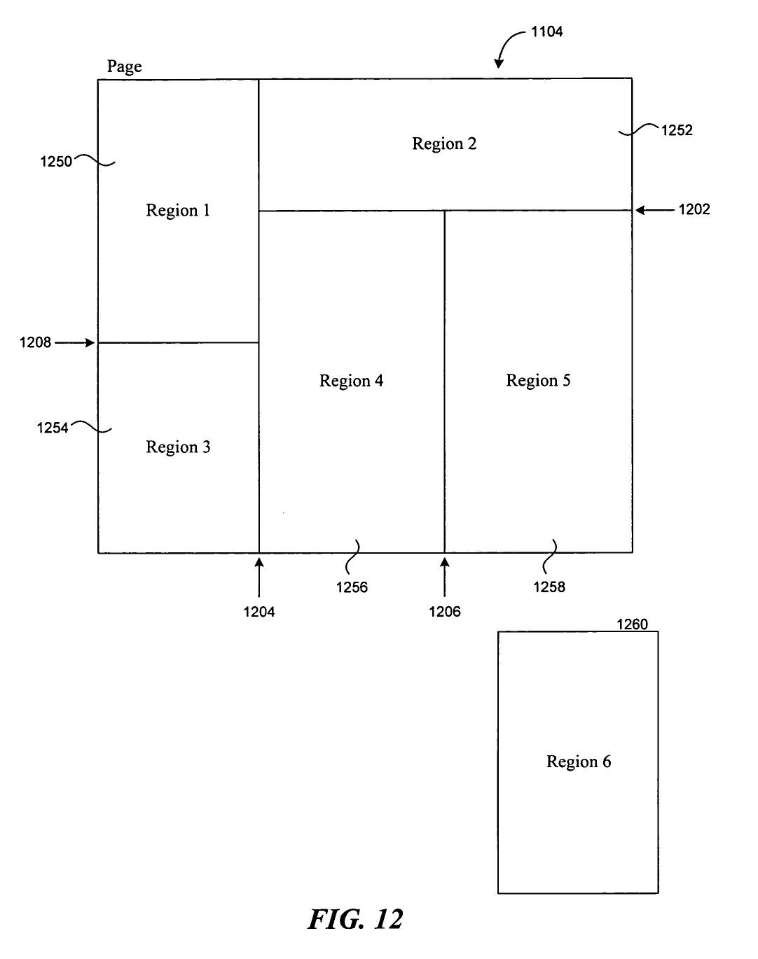

The tabs 1102 may be employed by a user to select a page. Each page corresponds to a “context.” A context is a particular task that the user seeks to complete. As an example, a context may be “invoice payment.” Because information relating to pages and regions is stored separately from the application, such as using metadata information in a database, the UI is dynamically rendered at run-time depending on the user's context. Each task may comprise multiple pages. Each page may be further divided into multiple regions, as illustrated in further detail below in relation to FIG. 12.

The pushpin 1106 may be employed by a user to separate the task pane from the application.

FIG. 12 is a block diagram illustrating a page of FIG. 11 in further detail. In some embodiments, the page 1104 has multiple regions, such as regions 1250, 1252, 1254, 1256, 1258, and 1260. The regions may be individually resizable, such as using resize handles 1202, 1204, 1206, or 1208. When a user resizes a region, other regions may be automatically resized. As an example, if a user slides resize handle 1202 up or down, regions 4 and 5 will also be resized.

As illustrated, regions can be detached to create a “floating” region, as illustrated by region 1260. Context information determines which regions to create. As an example, accounting information may be displayed in a newly added region when the context involves paying invoices.

Some regions may be indicated to be un-resizable. In some embodiments, a user may expand or shrink a region by clicking on an icon. As an example, a user can minimize a region. When a minimized region is expanded, its content may be created on demand, such as by looking up the content from a database. Each region can have its own context menu. Regions can be linked. As an example, a user can follow a link, such as by using a menu, button, hyperlink, or other means, to change the current context. When the user changes the current context, the form updates itself.

History of user interaction is preserved, so that the user can navigate back to a prior context or forward to another context. When a user performs this navigation, the content of the task pane changes accordingly.

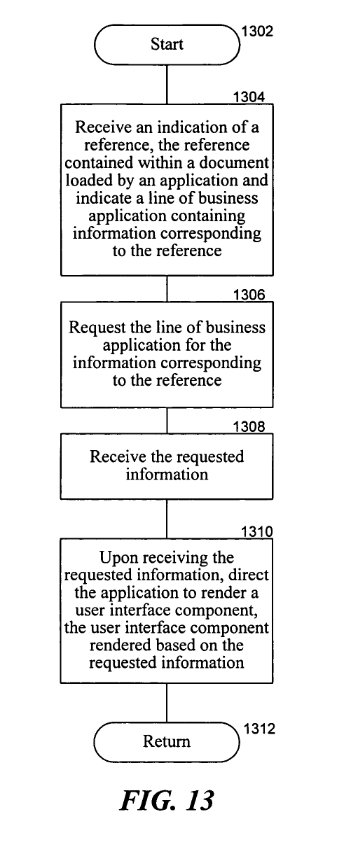

FIG. 13 is a flow diagram illustrating a routine performed by an aspect of the facility in some embodiments. The routine begins at block 1302.

At block 1304, the routine receives an indication of a reference. The reference is contained within a document loaded by an application and indicates an LOB application containing information corresponding to the reference.

At block 1306, the routine requests the LOB application for the information corresponding to the reference.

At block 1308, the routine receives the requested information, and upon receiving the requested information, at block 1310 it directs the application to render a UI component. The UI component is rendered based on the requested information.

The routine returns at block 1312.

### EXAMPLES OF METADATA

The following metadata defines two default actions:

EnterContext and GetMyBugsFromDefaultProduct. The default actions comprise multiple operations. As an example, a QueryMenu operation queries the metadata to discover a menu to associate with this action; a ShowAssociations operation displays this menu; and a ShowRegion operation instructs the runtime to show a UI region displaying the information from the service. Additionally, a BugSummaryRegions metadata section is an XSL transform embedded in the metadata that shows various information related to a bug.

```
<Action Name=“EnterContext” Type=“EnterContext” InputSchemaName=“ArrayOfBug”
IsSequentialExecution=“true”>
              <MenuItemDefinition MenuType=“0”>
              </MenuItemDefinition>
              <OperationInstances>
                <OperationInstance OperationName=“QueryMenu” Index=“1”>
                </OperationInstance>
                <OperationInstance OperationName=“ShowAssociations”
Index=“2”>
                  <TransformationInstances>
                    <TransformationInstance Index=“1”
InputOperationIndex=“1” InputOperationOutputSchemaIndex=“1”>
                    </TransformationInstance>
                  </TransformationInstances>
                </OperationInstance>
                <OperationInstance OperationName=“ShowRegion” Index=“3”>
                  <TransformationInstances>
                    <TransformationInstance
TransformationName=“BugListRegionTransformation” Index=“1”
InputOperationIndex=“−1” InputOperationOutputSchemaIndex=“1”>
                    </TransformationInstance>
                  </TransformationInstances>
                </OperationInstance>
                </OperationInstances>
            </Action>
            <Action Name=“GetMyBugsFromDefaultProduct”
IsSequentialExecution=“false”>
              <MenuItemDefinition MenuType=“0”>
              </MenuItemDefinition>
              <OperationInstances>
                <OperationInstance
OperationName=“GetDefaultProductNameOperation” Index=“1”>
                </OperationInstance>
                <OperationInstance OperationName=“Query” Index=“2”>
                  <TransformationInstances>
                    <TransformationInstance
TransformationName=“MyActiveBugsQueryTransformation” Index=“1”
InputOperationIndex=“1” InputOperationOutputSchemaIndex=“1”>
                    </TransformationInstance>
                  </TransformationInstances>
                </OperationInstance>
                <OperationInstance OperationName=“ReturnActionResult”
Index=“3”>
                  <TransformationInstances>
                    <TransformationInstance Index=“1”
InputOperationIndex=“2” InputOperationOutputSchemaIndex=“1”>
                    </TransformationInstance>
                  </TransformationInstances>
                </OperationInstance>
              </OperationInstances>
            </Action>
    <Port xsi:type=“PortFileXml” Name=“BugSummaryRegions” IsCached=“false”
AuthenticationTypeValue=“Windows”>
      <Data>
        <xsl:stylesheet version=“1.0”
xmlns:xsl=“http://www.w3.org/1999/XSL/Transform”
xmlns:msibf=“http://schemas.microsoft.com/InformationBridge/2004”
xmlns:ps=“http://microsoft.com/solutions/ProductStudio”>
          <xsl:template match=“/”>
            <xsl:param name=“changeListCount”>
              <xsl:choose>
                <xsl:when test=“string-
length(string(//ps:FieldDefinition[@Name=‘ChangeListInfo’]/ps:Value)) =
0”>0</xsl:when>
                <xsl:otherwise>
                  <xsl:value-of select=“1 + string-
length(string(//ps:FieldDefinition[@Name=‘ChangeListInfo’]/ps:Value)) − string-
length(translate(string(//ps:FieldDefinition[@Name=‘ChangeListInfo’]/ps:Value),
‘&#xA;’, ‘’))”>
                  </xsl:value-of>
                </xsl:otherwise>
              </xsl:choose>
            </xsl:param>
            <Associations
xmlns=“http://schemas.microsoft.com/InformationBridge/2004”>
              <Region Enabled=“true”>
                <RegionProperties Description=“Related Links”
ShowAs=“CollapsedRegion”
TypeName=“Microsoft.InformationBridge.Framework.UI.Controls.ReferenceListRegion”>
                  <xsl:attribute name=“Caption”>Related Links (<xsl:value-of
select=“string(count(//ps:RelatedLinks/ps:BugReference))”></xsl:value-
of>)</xsl:attribute>
                  <AnnotatedReferences>
                    <xsl:apply-templates
select=“//ps:RelatedLinks/ps:BugReference”>
                    </xsl:apply-templates>
                  </AnnotatedReferences>
                </RegionProperties>
              </Region>
              <Region Enabled=“true”>
                <RegionProperties Description=“Duplicate Bugs”
ShowAs=“CollapsedRegion”
TypeName=“Microsoft.InformationBridge.Framework.UI.Controls.ReferenceListRegion”>
                  <xsl:attribute name=“Caption”>Duplicates (<xsl:value-of
select=“string(count(//ps:DuplicateIDs/ps:BugReference))”></xsl:value-
of>)</xsl:attribute>
                  <AnnotatedReferences>
                    <xsl:apply-templates
select=“//ps:DuplicateIDs/ps:BugReference”>
                    </xsl:apply-templates>
                  </AnnotatedReferences>
                </RegionProperties>
              </Region>
              <Region Enabled=“true”>
                <RegionProperties Description=“Bug Change Lists”
ShowAs=“CollapsedRegion”
TypeName=“Microsoft.InformationBridge.Framework.UI.Controls.ReferenceListRegion”>
                  <xsl:attribute name=“Caption”>Source Depot (<xsl:value-of
select=“$changeListCount”></xsl:value-of>)</xsl:attribute>
                  <AnnotatedReferences>
                    <xsl:call-template name=“loop”>
                      <xsl:with-param name=“index”>
                        <xsl:value-of select=“$changeListCount”>
                        </xsl:value-of>
                      </xsl:with-param>
                      <xsl:with-param name=“text”>
                        <xsl:value-of
select=“string(//ps:FieldDefinition[@Name=‘ChangeListInfo’]/ps:Value)”>
                        </xsl:value-of>
                      </xsl:with-param>
                    </xsl:call-template>
                  </AnnotatedReferences>
                </RegionProperties>
              </Region>
            </Associations>
          </xsl:template>
          <xsl:template name=“loop”>
            <xsl:param name=“index”>
            </xsl:param>
            <xsl:param name=“text”>
            </xsl:param>
            <xsl:if test=“$index &gt; 0”>
              <xsl:variable name=“currenttext”>
                <xsl:choose>
                  <xsl:when test=“contains($text,‘&#xA;’)”>
                    <xsl:value-of select=“substring-before($text,‘&#xA;’)”>
                    </xsl:value-of>
                  </xsl:when>
                  <xsl:otherwise>
                    <xsl:value-of select=“$text”>
                    </xsl:value-of>
                  </xsl:otherwise>
                </xsl:choose>
              </xsl:variable>
              <xsl:variable name=“remainingtext”>
                <xsl:value-of select=“substring-after($text,‘&#xA;’)”>
                </xsl:value-of>
              </xsl:variable>
              <xsl:call-template name=“annotatedreference”>
                <xsl:with-param name=“id”>
                  <xsl:value-of select=“substring-before($currenttext,‘,’)”>
                  </xsl:value-of>
                </xsl:with-param>
                <xsl:with-param name=“caption”>
                  <xsl:value-of select=“substring-before($currenttext,‘,’)”>
                  </xsl:value-of>
                </xsl:with-param>
                <xsl:with-param name=“description”>Port: <xsl:value-of
select=“substring-before(substring-after($currenttext,‘,’),‘,’)”></xsl:value-of>
Resolution: <xsl:value-of select=“substring-before(substring-after(substring-
after($currenttext,‘,’), ‘,’),‘,’)”></xsl:value-of>
User:  <xsl:value-of select=“substring-before(substring-after(substring-
after(substring-after($currenttext,‘,’), ‘,’), ‘,’),‘,’)”></xsl:value-of>
Date:  <xsl:value-of select=“substring-before(substring-after(substring-
after(substring-after(substring-after($currenttext,‘,’), ‘,’), ‘,’),
‘,’),‘,’)”></xsl:value-of></xsl:with-param>
              </xsl:call-template>
              <xsl:call-template name=“loop”>
                <xsl:with-param name=“index”>
                  <xsl:value-of select=“$index − 1”>
                  </xsl:value-of>
                </xsl:with-param>
                <xsl:with-param name=“text”>
                  <xsl:value-of select=“$remainingtext”>
                  </xsl:value-of>
                </xsl:with-param>
              </xsl:call-template>
            </xsl:if>
          </xsl:template>
          <xsl:template name=“annotatedreference”>
            <xsl:param name=“id”>
            </xsl:param>
            <xsl:param name=“caption”>
            </xsl:param>
            <xsl:param name=“description”>
            </xsl:param>
            <msibf:AnnotatedReference>
              <xsl:attribute name=“Caption”>
              <xsl:value-of select=“$caption”>
              </xsl:value-of>
            </xsl:attribute>
            <xsl:attribute name=“Description”>
              <xsl:value-of select=“$description”>
              </xsl:value-of>
            </xsl:attribute>
            <ChangeListReference
xmlns=“http://microsoft.com/solutions/SourceDepot”>
                <xsl:attribute name=“ID”>
                  <xsl:value-of select=“$id”>
                  </xsl:value-of>
                </xsl:attribute>
                <xsl:attribute
namespace=“http://schemas.microsoft.com/InformationBridge/2004”
name=“MetadataScopeName”>http://microsoft.com/solutions/SourceDepot</xsl:attribute>
                <xsl:attribute
namespace=“http://schemas.microsoft.com/InformationBridge/2004”
name=“EntityName”>ChangeList</xsl:attribute>
                <xsl:attribute
namespace=“http://schemas.microsoft.com/InformationBridge/2004”
name=“ViewName”>DefaultView</xsl:attribute>
                <xsl:attribute
namespace=“http://schemas.microsoft.com/InformationBridge/2004”
name=“ReferenceSchemaName”>ChangeListReference</xsl:attribute>
              </ChangeListReference>
            </msibf:AnnotatedReference>
          </xsl:template>
          <xsl:template match=“ps:BugReference”>
            <msibf:AnnotatedReference>
              <xsl:attribute name=“Caption”>
                <xsl:value-of select=“@id”>
                </xsl:value-of>
              </xsl:attribute>
              <xsl:attribute name=“Description”>
                <xsl:value-of select=“@Title”>
                </xsl:value-of>
              </xsl:attribute>
              <xsl:copy>
                <xsl:copy-of select=“@*”>
                </xsl:copy-of>
                <xsl:attribute
namespace=“http://schemas.microsoft.com/InformationBridge/2004”
name=“MetadataScopeName”>http://microsoft.com/solutions/ProductStudio</xsl:attribute>
                <xsl:attribute
namespace=“http://schemas.microsoft.com/InformationBridge/2004”
name=“EntityName”>Bug</xsl:attribute>
                <xsl:attribute
namespace=“http://schemas.microsoft.com/InformationBridge/2004”
name=“ViewName”>BugSummary</xsl:attribute>
                <xsl:attribute
namespace=“http://schemas.microsoft.com/InformationBridge/2004”
name=“ReferenceSchemaName”>BugReference</xsl:attribute>
              </xsl:copy>
            </msibf:AnnotatedReference>
          </xsl:template>
        </xsl:stylesheet>
      </Data>
    </Port>
```

Those skilled in the art will appreciate that the steps shown in the flow diagrams and discussed above may be altered in various ways. For example, the order of the steps may be rearranged, substeps may be performed in parallel, shown steps may be omitted, other steps may be included, etc.

It will be appreciated by those skilled in the art that the above-described facility may be straightforwardly adapted or extended in various ways. For example, the facility may be used with various operating systems, windowing systems, and computing devices. While the foregoing description makes reference to particular embodiments, the scope of the invention is defined solely by the claims that follow and the elements recited therein.

We claim:

1. A method performed by a computer system for providing flexible data-bound user interfaces, comprising:
receiving an indication of a reference, the reference contained within a document loaded by a client application and indicating a line of business application containing information corresponding to the reference;
requesting the line of business application for the information corresponding to the reference;
receiving the requested information; and
upon receiving the requested information, directing the client application to render a user interface component, the user interface component rendered based on the received information.

2. The method of claim 1 wherein the reference has a scheme portion and a scheme-specific portion, the scheme portion for identifying the line of business application.

3. The method of claim 1 wherein the directing includes invoking an object model of the client application.

4. The method of claim 3 wherein the invoking includes invoking a method to create a task pane.

5. The method of claim 1 wherein the received information includes rendering information and line of business information.

6. The method of claim 5 wherein the rendering information comprises metadata.

7. The method of claim 6 wherein the metadata is defined by an extensible markup language.

8. The method of claim 1 wherein the requesting includes sending a request to a web service corresponding to the line of business application.

9. The method of claim 1 including providing the received information to a user interface engine.

10. The method of claim 1 including querying for actions provided by the line of business application.

11. A computer-readable medium having computer-executable instructions for providing flexible data-bound user interfaces, the method comprising:
receiving an indication of a reference, the reference contained within a document loaded by a client application and having a scheme portion and a scheme-specific portion, the scheme portion for identifying a line of business application and the scheme-specific portion for identifying requested information;
selecting, based on the scheme portion of the reference, a line of business component from a set of line of business components; and
requesting the selected line of business component to provide the requested information corresponding to the scheme-specific portion of the reference.

12. The computer-readable medium of claim 11 including receiving the requested information.

13. The computer-readable medium of claim 12 including sending the received information to a user interface engine.

14. The computer-readable medium of claim 11 including directing the client application to render a user interface component based on rendering information contained in the received information.

15. The computer-readable medium of claim 14 including processing user interface rendering information that is defined declaratively.

16. The computer-readable medium of claim 15 wherein a declarative definition indicates to create a task pane associated with the client application.

17. The computer-readable medium of claim 15 wherein a declarative definition indicates to add line of business data to the document loaded by the client application.

18. A system for flexibly securing remotely accessed networks, comprising:
a client application that is capable of loading a document, the document containing a reference, the reference indicating a line of business application;
a data engine that exchanges information between the client application and the line of business application; and
a user interface engine that directs the client application to render a user interface component based on information received from the line of business application, the received information containing rendering information and line of business data.

19. The system of claim 18 wherein the data engine has a common component that provides a common interface to the client application and at least one line of business application that interfaces between the common component and a web service associated with the line of business application.

20. The system of claim 18 wherein the user interface engine separates the received information into rendering information and line of business data and employs an object model of the client application to render, according to the rendering information, a user interface component containing the line of business data.
